(19) United States
(12) Patent Application Publication
(10) Pub. No.: US 2021/0371240 A1
(43) Pub. Date: Dec. 2, 2021

(54) EMERGENCY TERMINAL STOPPING SYSTEMS

(71) Applicant: Otis Elevator Company, Farmington, CT (US)

(72) Inventors: Peter Herkel, Berlin (DE); Jan Ruhnke, Berlin (DE)

(21) Appl. No.: 17/099,486

(22) Filed: Nov. 16, 2020

(30) Foreign Application Priority Data
May 26, 2020 (EP) 20176602.9

(51) Int. Cl. B66B 5/00; B66B 5/06; B66B 5/28; B66B 3/02; B66B 1/50; B66B 1/34

(52) U.S. Cl. CPC B66B 5/0031; B66B 5/06; B66B 1/3492; B66B 3/02; B66B 1/50; B66B 5/284

(57) ABSTRACT

An emergency terminal stopping system for an elevator system, the emergency terminal stopping system including: a sensor configured to determine data related to the motion of an elevator car moving within an elevator hoistway; at least one elevator brake configured to halt the motion of the elevator car; at least one elevator safety gear device provided on the elevator car; and at least one buffer provided at a lower portion of the hoistway.

### FOREIGN PRIORITY

This application claims priority to European Patent Application No. 20176602.9, filed May 26, 2020, and all the benefits accruing therefrom under 35 U.S.C. § 119, the contents of which in its entirety are herein incorporated by reference.

### TECHNICAL FIELD

This disclosure relates to emergency terminal stopping systems, and to methods of operating emergency terminal stopping systems.

### BACKGROUND

Elevator systems generally comprise an elevator car moving within a hoistway between a plurality of landings. Elevator cars are guided by rails disposed in the hoistway.

Elevator systems may include one or more buffers which are mounted at the base of the elevator hoistway below the elevator car, and which are configured to stop the elevator car in the event that it moves downwards below its normal limit of travel, i.e. beyond the lower landing of the hoistway. For elevator systems which include a counterweight, one or more buffers may be also provided in the base of the hoistway below the counterweight providing a safety stop for the counterweight. Buffers may also be provided at an upper portion of the hoistway.

Various types of buffers are known, for example spring buffers, elastomer buffers, and oil buffers. Technical specifications vary across the world, but generally speaking buffers are rated with respect to the elevator operating speed and elevator size. For a given elevator system, the buffer has a rated speed which is the maximum speed of elevator car impact that can be withstood. Traditionally, oil buffers are used on elevators which travel at elevated speeds since these are able to adsorb the energy of higher speed impacts.

Generally, the motion of the elevator car is monitored and when an abnormal motion is detected that is indicative of travel beyond a predetermined lower terminal limit (lower limit of normal travel) or a predetermined upper terminal limit (upper limit of normal travel) an emergency terminal stopping (ETS) function activates an elevator brake with the aim of slowing the elevator car (and counterweight where provided) to the rated speed of the buffer before impact.

For example, if the elevator car is travelling downwards faster than a threshold speed for a given distance from the lower terminal limit, this indicates that it will travel beyond the lower terminal limit and impact the buffer too fast. Similarly, where an elevator system includes a counterweight, if the elevator car is travelling upwards faster than a threshold speed for a given distance from the upper terminal limit, this indicates that the counterweight will travel beyond the lower terminal limit and impact the counterweight buffer too fast and/or the elevator car may impact an upper buffer. In both of these cases, an elevator brake is activated in order to slow down the downwards motion of the elevator car (and the counterweight) to or below the rated speed of the respective buffer.

In some situations, the elevator car continues to accelerate in the time between detection of the abnormal motion and activation of the brake. In this case, the action of the brake may not be not sufficient to sufficiently slow down the elevator car or counterweight before impact with the buffer.

Therefore, there is a need to improve elevator emergency terminal stopping systems.

### SUMMARY

According to a first aspect of this disclosure there is provided an emergency terminal stopping system for an elevator system, the emergency terminal stopping system comprising: a sensor configured to determine data related to the motion of an elevator car moving within an elevator hoistway; at least one elevator brake configured to halt the motion of the elevator car; at least one elevator safety gear device provided on the elevator car; and at least one buffer provided at a lower portion of the hoistway. The controller is configured to receive data from the sensor relating to the motion of the elevator car; monitor a current speed of the elevator car with respect to a distance from a terminal limit of normal elevator car travel; detect an abnormal speed of the elevator car; activate the at least one elevator brake in response to a detected abnormal speed; monitor a current acceleration of the elevator car following activation of the main elevator brake; detect an abnormal acceleration of the elevator car; and activate the elevator safety gear device in response to a detected abnormal acceleration.

The controller may be configured to determine the car current speed of the elevator car from the data received from the sensor. The controller may be configured to determine the current acceleration of the elevator car from the data received from the sensor.

The elevator brake may be provided within a drive system of the elevator system. The elevator brake may be an overspeed governor, for example a mechanical overspeed governor or an electrically operated overspeed governor.

The controller may be configured to detect an abnormal speed by monitoring whether the current speed of the elevator car is below a threshold value for a determined direction of travel of the elevator car and a determined current position of the elevator car.

The controller may be configured to determine a direction of travel of the elevator car. The controller may be configured to determine a current position of the elevator car with respect to a lower terminal limit and/or an upper terminal limit.

The controller may be configured to perform a zone check of if no abnormal speed is detected. The zone check may include determining if the elevator car (or counterweight) is in a zone close to one of the terminal limits, in other words approaching the upper terminal limit TU or lower terminal limit TL. The zone check may include determining if the elevator car (or counterweight) is approaching one of the buffers.

The zone check may include determining if the elevator car (or counterweight) is in an upper terminal limit zone or a lower terminal limit zone. The upper terminal limit zone or a lower terminal limit zone may be defined by a predetermined distance Z from the upper terminal limit TU or lower terminal limit TL.

The controller may be configured to monitor the current acceleration of the elevator car when the elevator car is in a terminal limit zone (an upper terminal limit zone or lower terminal limit zone), detect an abnormal acceleration of the elevator car; and activate the elevator safety gear device in response to a detected abnormal acceleration.

The controller may be configured to monitor the current acceleration over a defined time period after activation of the brake. The time period may be in the range 200 ms to 800 ms. The time period may be in the range 200 ms to 700 ms. The time period may be in the range 300 ms to 600 ms. The time period may be in the range 300 ms to 500 ms.

The controller may be configured to monitor the current acceleration until the elevator car is at rest.

The controller may be configured to detect the abnormal acceleration by determining whether the current acceleration is greater than or equal to a threshold acceleration. The controller may be configured to detect the abnormal acceleration by determining whether the current acceleration is greater than or equal to zero m/s2 acceleration over the time period. The controller may be configured to detect the abnormal acceleration by determining the whether current acceleration is increasing over a time period.

The controller may be configured to detect the abnormal acceleration by determining whether the monitored acceleration is constant or increasing over a time period. The controller may be configured to detect the abnormal acceleration by determining that the elevator car is not slowing down over a defined time period. The abnormal acceleration can be defined as increasing acceleration over the time period. The controller may be configured to detect the abnormal acceleration by determining that the elevator car is not decelerating above a threshold deceleration over a defined time period.

The emergency terminal stopping system may include a load sensor provided on the elevator car. The emergency terminal stopping system may include an upper terminal limit sensor, configured to detect when an elevator car and/or a counterweight reaches the upper terminal limit of normal elevator travel. The emergency terminal stopping system may include a lower terminal limit sensor configured to detect when an elevator car and/or a counterweight reaches the lower terminal limit of normal elevator travel.

The controller may be configured to detect the abnormal acceleration by monitoring whether the current acceleration of the elevator car is below a threshold value for a determined direction of travel of the elevator car and a determined current position of the elevator car.

The sensor may be configured to provide positional and/or speed data for the elevator car. The sensor may be a position sensor. The sensor may be a speed sensor. The sensor may be an acceleration sensor. The sensor may include a position sensor and a speed sensor. The sensor may be provided on the elevator car. The sensor may be provided within a drive system of the elevator system.

The or each buffer may be a rubber buffer. The or each buffer may be an elastomer buffer. The or each buffer may be a polyurethane buffer. The or each buffer may be an oil buffer. The or each buffer may be a spring buffer.

According to a further aspect, there is provided an elevator system comprising: a hoistway extending between a plurality of landings; an elevator car configured for moving along the hoistway between the plurality of landings; and the emergency terminal stopping system as described above, wherein the at least one buffer is provided at a lower end of the hoistway below the elevator car.

The or each buffer may be a rubber buffer. The or each buffer may be an elastomer buffer. The or each buffer may be a polyurethane buffer. The or each buffer may be an oil buffer. The or each buffer may be a spring buffer.

At least one buffer may be provided below the elevator car. At least one buffer may be provided in an extension of a path of travel of the elevator car.

The sensor may be a position sensor. The sensor may be a speed sensor. The sensor may include a position sensor and a speed sensor. The sensor may be provided on the elevator car. The sensor may be provided within a drive system of the elevator system.

The elevator system may further comprise a counterweight, and at least one second buffer provided below the counterweight. At least one buffer may be provided in an extension of a path of travel of the counterweight. The or each second buffer may be an oil buffer. The or each second buffer may be a spring buffer. The or each second buffer may be a rubber buffer. The at least one buffer may be an elastomer buffer. The or each second buffer may be a polyurethane buffer.

According to a further aspect, there is provided a method for operating an emergency terminal stopping system, the method comprising: a) monitoring a current speed of an elevator car with reference to a distance from a terminal limit of normal elevator car travel; b) detecting an abnormal speed of the elevator car; c) activating an elevator brake in response to a detected abnormal speed; d) monitoring a current acceleration of the elevator car following activation of the elevator brake; e) detecting an abnormal acceleration of the elevator car; f) applying an elevator safety gear device when the monitored acceleration is determined to be abnormal.

The current speed of the elevator car may be determined by a speed sensor provided on the elevator car. The current speed of the elevator car may be determined by calculation using data from a position sensor on the elevator car. The current speed of the elevator car may be determined by a sensor provided within a drive system of the elevator car.

Step a) may include determining a direction of travel of the elevator car. Step a) may include determining a current position of the elevator car with respect to a lower terminal limit and/or an upper terminal limit.

When the elevator car is travelling upwards, the current position with respect to the upper terminal limit is determined. When the elevator car is travelling downwards, the current position with respect to the lower terminal limit is determined.

Step b) may include monitoring whether the current speed of the elevator car is below a threshold value for the determined direction of travel and the determined current position.

The step of monitoring the current speed of the elevator car may comprise determining a direction of travel of a counterweight. The step of monitoring the current speed of the elevator car may comprise determining a direction of travel of a counterweight. The step of monitoring the current speed of the elevator car may comprise determining a direction of travel of a counterweight with respect to a lower terminal limit and/or an upper terminal limit.

The method may include a step c1) performing a zone check of if no abnormal speed is detected in step b). Step c1) may include determining if the elevator car (or counterweight) is in a zone close to one of the terminal limits, in other words approaching the upper terminal limit TU or lower terminal limit TL. Step c1) may include determining if the elevator car (or counterweight) is approaching one of the buffers.

Step c1) may include determining if the elevator car (or counterweight) is in an upper terminal limit zone or a lower terminal limit zone. The upper terminal limit zone or a lower terminal limit zone may be defined by a predetermined distance Z from the upper terminal limit TU or lower terminal limit TL.

Step d) may include monitoring the current acceleration of the elevator car 4 when the elevator car is in a terminal limit zone (an upper terminal limit zone or lower terminal limit zone).

Step e) may include determining whether the current acceleration is greater than or equal to a threshold acceleration.

Step e) may include determining whether the deceleration of the elevator car is above a deceleration threshold.

Step e) may comprise determining whether current acceleration is greater than or equal to zero. Step d) may comprise determining whether the current acceleration is greater than or equal to zero.

The abnormal acceleration can be defined as greater than or equal to zero. The abnormal acceleration can be defined as greater than zero.

Step e) may include determining whether the current acceleration is increasing. Step e) may comprise determining whether current acceleration is increasing over a time period.

Step e) may comprise determining whether the acceleration is constant or increasing over a time period. Step e) may comprise determining that the elevator car is not slowing down over a defined time period.

The abnormal acceleration can be defined as increasing acceleration over the time period.

Step e) may comprise monitoring the current acceleration over a defined time period after activation of the main elevator brake.

Step e) may comprise monitoring the current acceleration until the elevator car has stopped. The time period may be in the range 200 ms to 800 ms. The time period may be in the range 200 ms to 700 ms. The time period may be in the range 300 ms to 600 ms. The time period may be in the range 300 ms to 500 ms.

Step e) may comprise monitoring a load of the elevator car. Step e) may comprise when the monitored load of the elevator car is above a threshold load, the acceleration is always determined to be abnormal.

Step e) may include identifying a buffer towards which the elevator car is travelling. Step e) may include checking the current speed of the elevator car against the rated speed of the buffer. Step e) may include when the current speed is below the rated speed, determining that the acceleration is not abnormal.

The system and method described above provide a reliable and economical solution, which can easily be retrofitted into existing elevator systems.

### DRAWING DESCRIPTION

Certain preferred examples of this disclosure will now be described, by way of example only, with reference to the accompanying drawings, in which:

FIG. 1 shows an elevator system according to an example of the present disclosure;

FIG. 2 shows an elevator system according to another example of the present disclosure;

FIG. 3 shows a method for operating an emergency terminal stopping system according to an example of the present disclosure;

FIG. 4 shows an example of a speed threshold profile which can be used in the method of FIG. 3;

FIG. 5 shows a method for operating an emergency terminal stopping system according to another example of the present disclosure; and

FIG. 6 shows an example of speed threshold profile which can be used in the method of FIG. 5.

### DETAILED DESCRIPTION

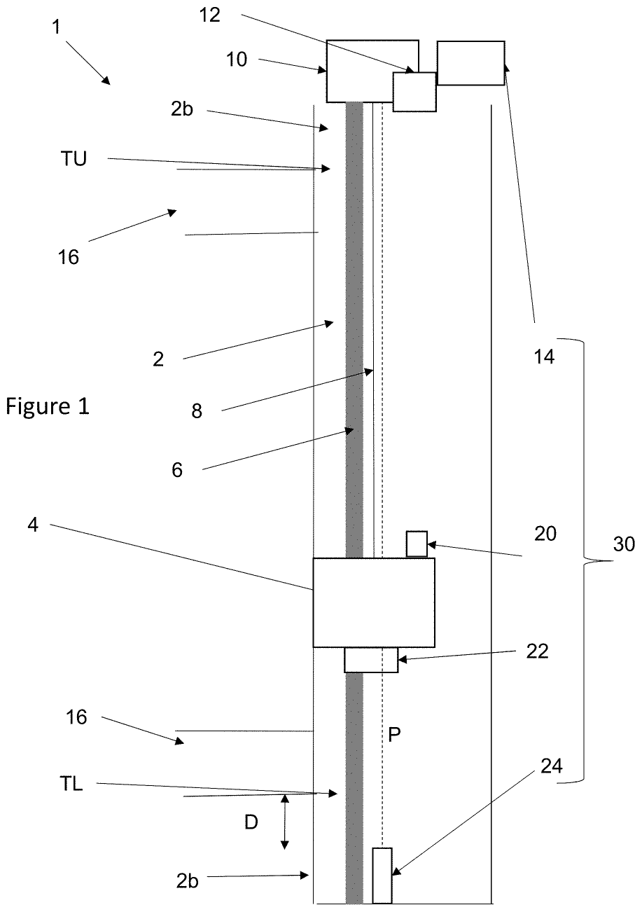

FIG. 1 shows a first example of an elevator system 1 comprising a hoistway 2 and an elevator car 4 which runs along a guide rail 6 within the hoistway 2. The elevator car 4 is moveably suspended by a tension member 8, for example a rope or belt. The tension member 8 is connected to a drive system 10 which is configured to drive the tension member 8 in order to move the elevator car 4, and which includes a brake 12. The drive system 10 may be any type of commonly used drive, such as but not limited to, a traction drive. The elevator car 4 moves between a plurality of landings 16. For ease of understanding only the upper and lower landings 16 are depicted in FIG. 1.

The elevator system 1 also includes a controller 14. The controller 14 is depicted as being in an upper portion 2b of the hoistway in FIG. 1. However, it will be appreciated that the controller 14 can be located in any suitable location within or near the hoistway 2. The term controller 14 is also understood to include multiple controller units provided within the elevator system 1.

In the example of FIG. 1, a sensor 20 is provided on the elevator car 4. The sensor 20 is configured to monitor the motion of the elevator car 4. The sensor 20 is configured to monitor a current position and/or a current speed of the elevator car 4. Data from the sensor 20 is sent to the controller 14.

The sensor 20 can be any suitable sensor which is configured to provide data related to the current position and/or current speed of the elevator car 4. The sensor 20 may be a position sensor 20, for example an absolute position determination sensor or an incremental position determination sensor. Data relating to the current position of the elevator car 4 is transmitted to the controller 14 which then uses the positional data to determine the current speed of the elevator car 4. The sensor 20 may include a speed sensor in addition to or instead of the position sensor. Where only a speed sensor is provided, the controller 14 determines positional information from the speed data.

The elevator car 4 is also provided with one or more elevator safety gear devices 22 (also known as safeties), which clamp onto the elevator guide rails 4 when activated.

A buffer 24 is provided in a lower portion 2a of the hoistway 2, which is the region below the lower landing 16. The lower portion 2a of the hoistway 2 is sometimes referred to as the hoistway pit. The buffer 24 is located below the elevator car 4, below an extension of a path of travel of the elevator car 4. The buffer 24 is provided at a distance D below the lower terminal limit TL of the elevator car 4. Whilst one buffer 24 is shown in FIG. 1, it will be appreciated that in other examples, two or more buffers 24 may be provided.

An upper terminal limit TU of the elevator car 4 is shown at the upper portion 2b of the hoistway 2.

An emergency terminal stopping system 30 includes the sensor 20, the controller 14, the brake 12, the elevator safety gear device 22, and the buffer 24.

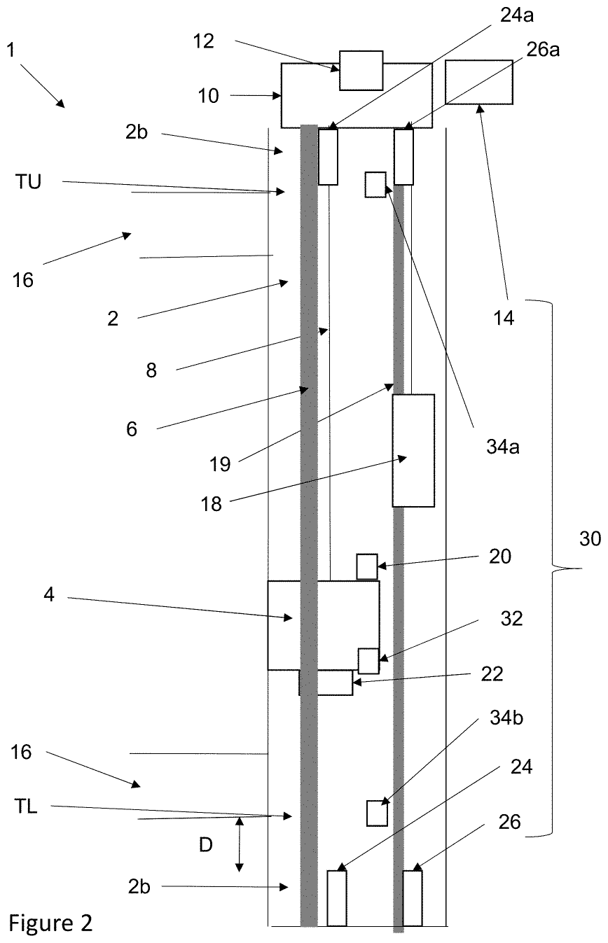

FIG. 2 shows a second example of an elevator system 1. Components which are the same as those described above are provided with the same reference numerals.

In FIG. 2, the elevator system 1 also includes a counterweight 18 which moves concurrently and in an opposite direction to the elevator car 4. The counterweight 18 runs along a guide rail 19 and is moveably suspended to a second end of the tension member 8.

The elevator system 1 of FIG. 2 includes a second buffer 26 provided below the counterweight 18, below an extension of a path of travel of the counterweight 18. Whilst one second buffer 26 is shown in FIG. 2, it will be appreciated that in other examples, two or more second buffers 26 may be provided.

FIG. 2 also shows two upper buffers 24a and 26a provided in the upper portion 2b of the hoistway 2 and aligned with the travel paths of the elevator car 24 and the counterweight 18. The upper buffers 24a, 26a are provided to slow down the elevator car 4/counterweight 18 in the event that it travels beyond the upper terminal limit TU. This could happen, for example, in a situation where power is lost to the drive system 10 and the elevator car 4 has relatively small load (for example no passengers). In this situation, the counterweight 18 would cause the elevator car 4 to accelerate upwards towards the upper buffer 24a.

In the situation opposite to the one previously described, i.e. where a heavily loaded elevator car 4 is accelerating downwards, it will be appreciated that the counterweight 18 is accelerating upwards towards the upper buffer 26a.

The elevator system 1 of FIG. 2 may also include a load sensor 32 provided on the elevator car 4, the load sensor 32 being configured to monitor the loading on the elevator car 4. It will be appreciated that a load sensor 32 could also be provided in the example of FIG. 1.

The elevator system 1 of FIG. 2 may also include an upper terminal limit sensor 34a and a lower terminal limit sensor 34b. The upper and lower terminal limit sensors 34a, 34b are configured to detect when the elevator car 4 reaches the upper or lower terminal limit TU, TL. It will be appreciated that the terminal limit sensors 34a, 34b could also be provided in the example of FIG. 1.

An emergency terminal stopping system 30 of FIG. 2 includes: the sensor 20, the controller 14, the brake 12; the elevator safety gear device 22, and the buffers 24, 24a, 26, 26b

The emergency terminal stopping system 30 may also include the load sensor 32, when provided. Similarly, the emergency terminal stopping system 30 may also include the upper and lower terminal limit sensors 34a, 34b.

In other examples (not shown), the sensor 20 may be provided on another component within the elevator system 1. For example, a sensor 20 may provided within the drive system 10 and configured to monitor movement of components within the drive system 10. The current speed of the elevator car 4 can be determined and monitored by the controller 14 using data from such a sensor 20.

In other examples (not shown), the elevator system 1 includes a drive system 10 which operates without a tension member 8, such as for example a hydraulic drive or a linear drive.

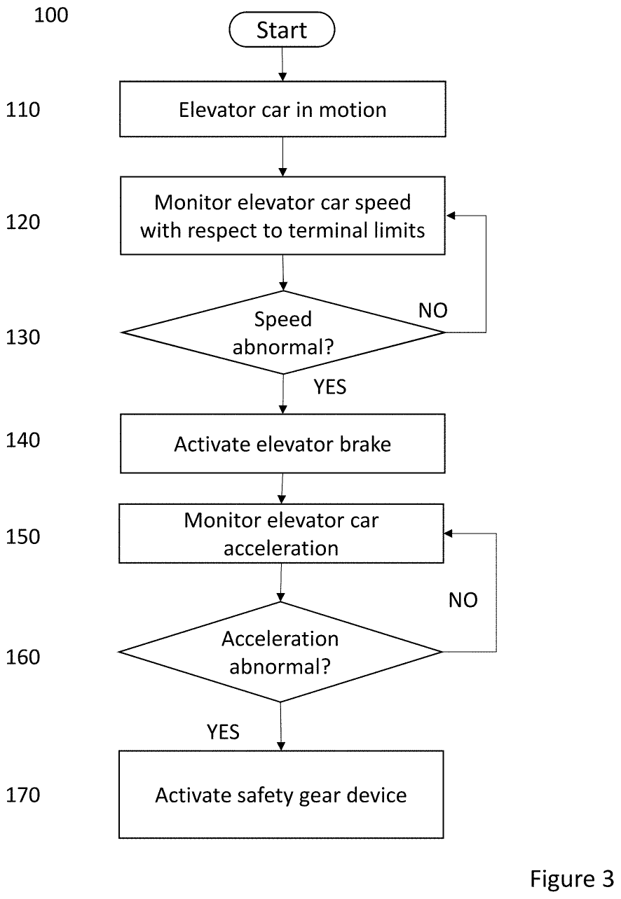

FIG. 3 shows an exemplary method 100 for operating the emergency terminal stopping system 30 as described in the examples described above.

In step 110, the controller 14 detects that the elevator car 4 is in motion. This can be done by monitoring signals from the sensor 20. Alternatively, the controller 14 can use any other suitable way, for example but not limited to using data provided by an accelerometer provided on the elevator car 4. The accelerometer may be provided as part of the sensor 20 described above, or as an additional component provided independently on the elevator car 4.

Once the elevator car 4 is in motion, in step 120, the controller 14 monitors a current speed of the elevator car 4. The controller 14 receives data from the sensor 20 relating to the position and/or the speed of the elevator car 4. This data can be used directly or as a basis to calculate the current speed. The controller 14 also determines a direction of travel of the elevator car 4. In other words, a determination is made as to whether the elevator car 4 is travelling upwards or downwards.

In step 130, the controller 14 compares the determined current speed of the elevator car 4 to known data for the elevator system 1 to determine whether the current speed is abnormal. Exemplary methods for determining abnormal speed are described below.

The controller 14 determines whether the elevator car 4 is travelling downwards or upwards. This determination can be made using data from the sensor 20, and optionally from data received from terminal limit sensors 34a, 34b.

A distance D between the buffer 24 and the lower terminal limit TL and the rated speed R of the buffer 24 are both known. From this data, a threshold speed profile for downwards travel of the elevator car 4 is defined with respect to the distance to the lower terminal limit TL. The threshold speed profile represents a normal deceleration of the elevator car 4.

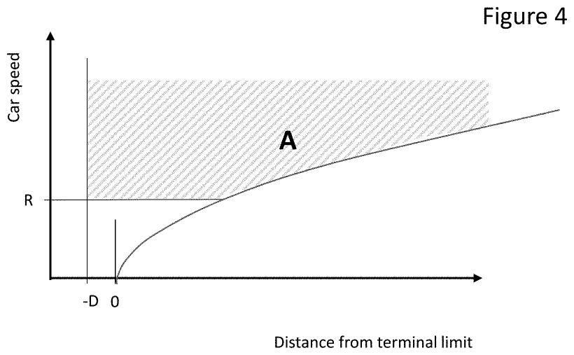

An example speed threshold profile is shown in FIG. 4, in which the distance from the lower terminal limit TL is represented on the x axis. The lower terminal limit TL is defined as zero on the x axis, and the buffer 24 is located at a distance −D from the lower terminal limit TL. The elevator car 4 speed is represented on the y axis, where R is the rated speed of the buffer 24. When the elevator car 4 is determined to be travelling downwards in the hoistway 2, its current speed is monitored against the speed threshold profile. If the current speed remains below the larger of the threshold line and the rated speed R, then the elevator car 4 is anticipated to be able to slow down to or below the rated speed R. In other words, if the elevator car 4 impacts the buffer, the buffer 24 will be within its safe operational range. In this case the speed is determined to be not abnormal.

However, if the current speed exceeds the threshold value for a given distance from the lower terminal limit TL and the current speed is above the rated speed R (i.e. in the shaded area indicated by A), it will not be possible for the elevator car 4 to slow down to below the rated speed R before the elevator car 4 impacts the buffer 24. In this case, the controller 14 determines that the speed is abnormal.

The same profile can be used for determining abnormal speed when the elevator car is travelling upwards.

Whilst one example is described above, alternative methods of determining abnormal speed may be used.

If it is determined that the speed of elevator car 4 is not abnormal, the controller 14 continues to monitor the current speed of the elevator car 4, i.e. steps 120 and 130 are repeated.

If it is determined that the elevator car 4 is travelling at an abnormal speed, the elevator brake 12 is activated in step 140.

In step 150, after activation of the brake 12, the controller 14 monitors the current acceleration of the elevator car 4. The controller 14 receives data from the sensor 20 relating to the position and/or the speed of the elevator car 4. This data can be used directly or as a basis to calculate the current acceleration. The controller 14 may also determine a direction of travel of the elevator car 4. In other words, a determination is made as to whether the elevator car 4 is travelling upwards or downwards.

In step 160, the controller 14 compares the determined current acceleration of the elevator car 4 to known data for the elevator system 1 to determine whether the current acceleration is abnormal. The aim is to identify situations where the elevator car 4 is not sufficiently slowed by the brake 12.

The controller 14 determines whether the current acceleration is abnormal, wherein abnormal acceleration means that the elevator car 4 is likely to not be slowed sufficiently before it reaches the buffer 24, 24a towards which it is travelling. If the elevator car continues to accelerate, this means that the elevator car 4 is continuing to speed up, and so the elevator car 4 will reach the buffer 24 at an even higher speed, which would be a larger overload on the buffer 24.

Exemplary methods for determining abnormal acceleration are described below.

In step 160, the detection of abnormal acceleration may include determining whether the current acceleration is greater than or equal to a threshold acceleration. Additionally or alternatively, the detection of abnormal acceleration includes determining whether the current acceleration is increasing.

Step 160 may include determining whether the deceleration of the elevator car 4 is above a deceleration threshold. In this situation, after triggering the brake 12, it is expected that the elevator car 4 will decelerate sufficiently in a certain time period to reduce the current speed of the elevator car 4 to a value below the rated buffer speed R. Therefore, the deceleration (i.e. speed reduction) can be monitored to detect abnormal behaviour. If it is determined that the deceleration is below the deceleration threshold, in other words it is not decelerating fast enough for whatever reason, this would indicate that the elevator car 4 (or counterweight 18) might hit the buffer with a higher speed than the rated buffer speed R. In this case, the acceleration is determined to be abnormal.

The controller 14 may determine whether the elevator car 4 is travelling downwards or upwards. This determination can be made using data from the sensor 20, and optionally from data received from terminal limit sensors 34a, 34b. The determined direction may be used in the determination of abnormal acceleration.

In some circumstances, an abnormal load in the elevator car 4 may cause abnormal acceleration, for example if the elevator car 4 is moving downwards, a heavily loaded elevator car 4 may continue to accelerate, or if the elevator car 4 is moving upwards with a small load, the counterweight 18 may cause the elevator car 4 to be accelerated upwards. Therefore, step 160 may also include monitoring a load of the elevator car 4 using the load sensor 32 and determining an abnormal acceleration based on the determined load and the direction of travel. When the elevator car 4 is moving downwards, and the monitored load of the elevator car 4 is above an upper threshold load i.e. the elevator car 4 is heavily loaded, the acceleration is determined to be abnormal. When the elevator car 4 is moving upwards and the monitored load of the elevator car 4 is below a lower threshold load, the acceleration is determined to be abnormal.

Step 160 may also include determining that the elevator car 4 has reached the upper or lower terminal limit TU, TL using data from the terminal limit sensors 34a, 34b. If the current speed of the elevator car 4 is above the rated speed R of the buffer towards it is travelling when the elevator car 4 passes the upper or lower terminal limit TU, TL, a determination is made that the acceleration is abnormal.

Step 160 may also include determining that the counterweight 18 has reached the upper or lower terminal limit TU, TL using data from the terminal limit sensors 34a, 34b. If the current speed of the counterweight 18 is above the rated speed R of the buffer towards it is travelling when the counterweight 18 passes the upper or lower terminal limit TU, TL, a determination is made that the acceleration is abnormal

It will be appreciated that step 160 may include one or more of the ways of determining abnormal acceleration outlined above.

In step 160, the acceleration of the elevator car 4 may be monitored until the elevator car 4 comes to rest. Alternatively, the acceleration of the elevator car 4 may be monitored over a defined time period t, where the time period t is dependent on the activation time of the brake 12. The acceleration of the elevator car 4 should be monitored for a time period t which is at least as long as the activation time of the brake 12 in order to determine whether the action of the brake 12 alone is enough to slow the elevator car 4.

If the acceleration is determined to not be abnormal, the controller 14 continues to monitor the current acceleration of the elevator car 4, i.e. steps 150 and 160/260 are repeated. The monitoring of acceleration continues until the elevator car 4 is at rest or the time period t has expired.

If the controller 14 determines that the acceleration of the elevator car 4 is abnormal, then the controller 14 activates the safety gear device 22 in addition to the brake 12 in step 170. The safety gear device 22 reaction time is faster than that of the brake 12, and so the speed of the elevator car 4 is reduced more quickly.

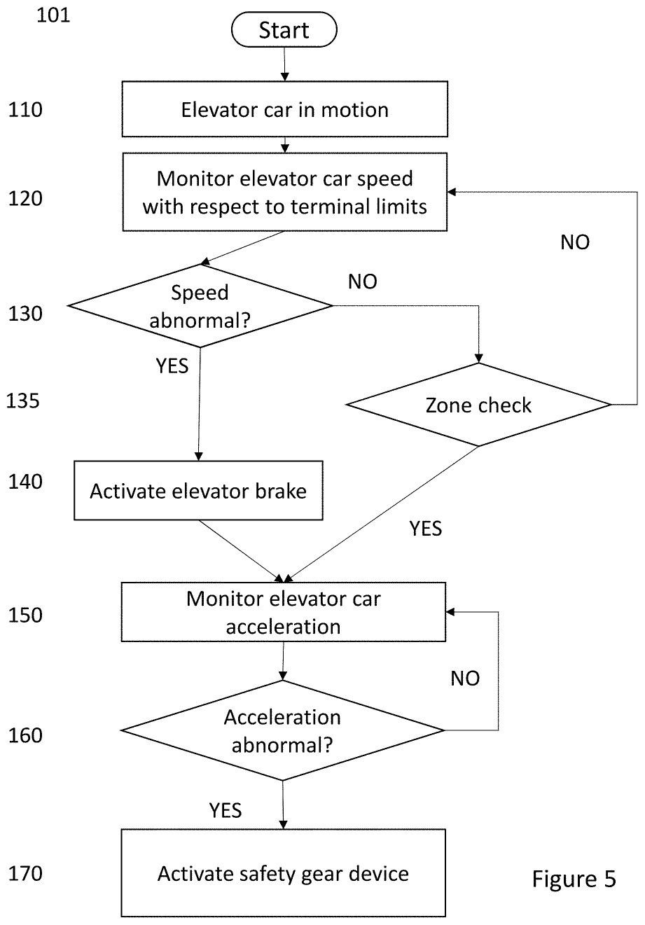

FIG. 5 shows another exemplary method 101 for operating the emergency terminal stopping system 30 as described in the examples described above. The method 101 is a modified version of the method described above with reference to FIG. 3 which includes steps 110, 120, 130, 140, 150, 160 and 170 as described above.

In method 101, if the current speed is determined not to be abnormal in step 130, an additional step 135 is performed. Step 135 is a zone check, in which the controller 14 determines if the elevator car 4 is in a zone close to one of the terminal limits, in other words approaching the upper terminal limit TU or lower terminal limit TL and therefore also approaching one of the buffers 24, 24a, 26, 26a.

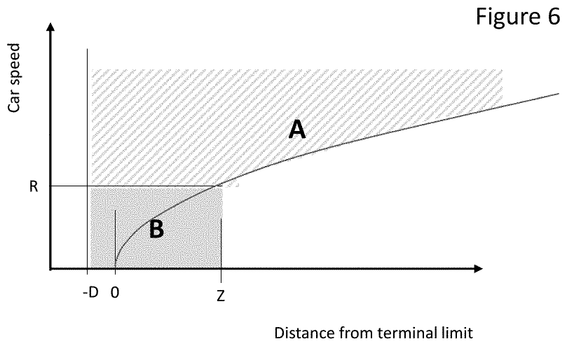

The upper terminal limit zone and lower terminal limit zone are defined by a predetermined distance Z from the upper terminal limit TU or lower terminal limit TL, which is determined by the characteristics of the elevator system 1. This is represented in FIG. 6. The shaded area B represents the situation when it is determined that the speed is not abnormal (i.e. not within area A), but the elevator car 4 is less than a distance Z from the terminal limit. Therefore, the distance Z is defined as where the threshold speed equals the rated speed R of the buffer 24, 24a, 26, 26a. Therefore, the distance Z is determined by the threshold speed for “abnormal speed” and the rated speed of the buffer.

If the elevator car 4 is in a terminal limit zone (an upper terminal limit zone or lower terminal limit zone), then the controller 14 monitors the current acceleration of the elevator car 4 in step 150. This allows the system to detect abnormal acceleration close to the upper terminal limit TU or lower terminal limit TL even if the current speed of the elevator car 4 has not exceeded the rated speed R. This would detect the situation where the elevator car 4 starts to perform a normal run from landing adjacent to the terminal landing but is moving in the wrong direction, for example in a situation when the elevator car 4 starts an “upwards run” from the second to last landing, but instead of going up, it moves downwards. In this case, the elevator car 4 would start from speed zero, but if it were to it exceed the buffer speed R, it may be too close to the terminal limit to be stopped by just activating the brake 12. The emergency terminal stopping system 30 provides a countermeasure, it detects the abnormal acceleration while the elevator car 4 is moving towards the terminal limit, and activates the safety gear device 22.

The subsequent steps of determining abnormal acceleration 160 and applying the safety gear device 170 when appropriate are as outlined above.

If the elevator car 4 is not in a terminal limit zone, the controller 14 continues to monitor the current speed of the elevator car 4, i.e. steps 120 and 130 are repeated.

It will be appreciated by those skilled in the art that the disclosure has been illustrated by describing one or more specific aspects thereof, but is not limited to these aspects; many variations and modifications are possible, within the scope of the accompanying claims.

What is claimed is:

1. An emergency terminal stopping system (30) for an elevator system (1), the emergency terminal stopping system (30) comprising
a sensor (20) configured to determine data related to the motion of an elevator car (4) moving with an elevator hoistway (2);
at least one elevator brake (12) configured to halt the motion of the elevator car (4);
at least one elevator safety gear device (22) provided on the elevator car (4),
at least one buffer (24) provided at a lower portion (2a) of the hoistway (2); and
a controller (14) configured to
receive data from the sensor (20) relating to the motion of the elevator car (4);
monitor a current speed of the elevator car (4) with respect to a distance from a terminal limit of normal elevator car (4) travel;
detect an abnormal speed of the elevator car (4);
activate the at least one elevator brake (12) in response to a detected abnormal speed;
monitor a current acceleration of the elevator car (4) following activation of the at least one elevator brake (12);
detect an abnormal acceleration of the elevator car (4);
activate the elevator safety gear device (22) in response to a detected abnormal acceleration.

2. The emergency terminal stopping system (30) according to claim 1, wherein the controller (14) is configured to detect an abnormal speed by monitoring whether the current speed of the elevator car (4) is below a threshold value for a determined direction of travel of the elevator car (4) and a determined current position of the elevator car (4).

3. The emergency terminal stopping system (30) according to claim 1, wherein the controller (14) is configured to monitor the current acceleration over a defined time period (t) after activation of the at least one elevator brake (12).

4. The emergency terminal stopping system (30) according to claim 1, wherein the controller (14) is configured to detect the abnormal acceleration by determining whether the current acceleration is greater than or equal to a threshold acceleration.

5. The emergency terminal stopping system (30) according to claim 1, wherein the controller (14) is configured to detect the abnormal acceleration by monitoring whether the current acceleration of the elevator car (4) is below a threshold value for a determined direction of travel of the elevator car (4) and a determined current position of the elevator car (4).

6. The emergency terminal stopping system (30) according to claim 1, wherein the at least one buffer (24) is an elastomer buffer.

7. An elevator system (1) comprising:
a hoistway (2) extending between a plurality of landings (16);
an elevator car (4) configured for moving along the hoistway (2) between the plurality of landings (16); and
the emergency terminal stopping system (30) according to claim 1, wherein the at least one buffer (24) is provided at a lower end (2a) of the hoistway (2) below the elevator car (4).

8. The elevator system (1) according to claim 7, further comprising a counterweight (18), and at least one second buffer (26) provided below the counterweight (18).

9. A method (100, 101) for operating an emergency terminal stopping system (30), the method comprising:
a) monitoring a current speed of an elevator car (4) with reference to a distance from a terminal limit of normal elevator car (4) travel;
b) detecting an abnormal speed of the elevator car (4);
c) activating an elevator brake (12) in response to a detected abnormal speed;
d) monitoring a current acceleration of the elevator car (4) following activation of the elevator brake (12);
e) detecting an abnormal acceleration of the elevator car (4);
f) applying an elevator safety gear device (22) when the monitored acceleration is determined to be abnormal.

10. The method (100, 101) of claim 9, wherein a) further comprises
determining a direction of travel of the elevator car (4); and
determining a current position of the elevator car (4) with respect to a lower terminal limit (TU) or an upper terminal limit (TL).

11. The method (100, 101) of claim 10, wherein b) comprises monitoring whether the current speed of the elevator car (4) is below a threshold value for the determined direction of travel and the determined current position.

12. The method (100, 101) of claim 9, wherein e) comprises determining whether the current acceleration is greater than or equal to a threshold acceleration.

13. The method (100, 101) of claim 9, wherein e) comprises determining whether the current acceleration is increasing.

14. The method (100, 101) of claim 9, wherein e) comprises monitoring the current acceleration over a defined time period (t) after activation of the elevator brake (12).

15. The method (100, 101) of claim 10, further comprising:
c1) if no abnormal speed is detected; determining if the elevator car (4) is in an upper terminal limit zone or a lower terminal limit zone; and
wherein d) further includes monitoring the current acceleration of the elevator car (4) when the elevator car is in the upper terminal limit zone or the lower terminal limit zone.
